(19) United States
(12) Patent Application Publication
(10) Pub. No.: US 2008/0164814 A1
(43) Pub. Date: Jul. 10, 2008

(54) Plasma display device with heat discharge prevention

(76) Inventor: Ji-Suk Kim, Suwon-si (KR)

Correspondence Address: ROBERT E. BUSHNELL, 1522 K STREET NW, SUITE 300, WASHINGTON, DC, 20005-1202, US

(21) Appl. No.: 12/007,170

(22) Filed: Jan. 7, 2008

(30) Foreign Application Priority Data
Jan. 8, 2007 (KR) 10-2007-0002173

(51) Int. Cl. H01J 17/49; H01J 7/24

(52) U.S. Cl. 313/582; 313/47

(57) ABSTRACT

A plasma display device includes a radiation wave blocking structure for preventing discharged heat, generated inevitably as a result of discharge, from being emitted into the surrounding environment, thereby reducing discomfort normally experienced by users of plasma display devices due to the discharged heat. The plasma display device includes a plasma display panel (PDP) for realizing an image formed due to a discharge, and a heat prevention layer disposed on a side of an image display surface of the PDP. The heat prevention may be included in a directly attached filter or a glass filter, each of which includes a reflection prevention layer or an anti-glare layer, and an electromagnetic wave shielding layer.

### CLAIM OF PRIORITY

This application makes reference to, incorporates the same herein, and claims all benefits accruing under 35 U.S.C. §119 from an application earlier filled in the Korean Intellectual Property Office on the 8 Jan. 2007 and there duly assigned Serial No. 10-2007-0002173.

### BACKGROUND OF THE INVENTION

1. Technical Field

The present invention relates to a plasma display device and, more particularly, to a plasma display device which prevents discharged heat, generated inevitably as a result of discharge, from being emitted, thereby reducing discomfort normally experienced by a user of plasma display devices due to the discharged heat.

2. Related Art

Plasma display devices are flat display devices that display images using a gas discharge, and are considered to be the next generation of large-scale flat display devices due to their excellent display properties, such as high brightness, high contrast, lack of residual image, wide viewing angle, and a thin and large-scale display structure.

In general, a plasma display panel (PDP), which realizes a predetermined image in a plasma display device, includes a plurality of discharge cells interposed between first and second substrates disposed to face each other. In addition, discharge electrodes used to generate a discharge can be arranged along the lines of the discharge cells. In the PDP, a predetermined image recognized by a viewer is provided through a few steps of light-emitting processes described below. That is, a predetermined AC voltage is applied between the discharge electrodes so that a discharge occurs, discharge gas inside the discharge cells is excited to generate ultraviolet rays, and the ultraviolet rays are converted into visible rays by a fluorescent material coated on the inner walls of the discharge cells. Such visible rays penetrate the first substrate so as to be emitted to the exterior of the PDP so that a predetermined image can be formed.

As described above, plasma display devices realize images by using a discharge, and thus discharged heat is generated during operation thereof. A PDP in which a display discharge is generated is exposed to the surrounding environment through a window formed in a case or housing of the PDP or is disposed close to the surrounding environment. Accordingly, viewers in the surrounding environment may experience discomfort due to the discharged heat. Therefore, a new structure to prevent discharged heat from being emitted to the surrounding environment should be considered.

### SUMMARY OF THE INVENTION

The present invention provides a plasma display device which prevents discharged heat, generated inevitably as a result of discharge, from being emitted into the surrounding environment, thereby reducing discomfort normally experienced by a user of plasma display devices due to the discharged heat.

The present invention also provides a plasma display device having a thin display structure.

According to an aspect of the present invention, a plasma display device comprises: a plasma display panel (PDP) for realizing an image formed due to a discharge; and a heat prevention layer disposed on a side of an image display surface of the PDP.

The PDP may include: a plurality of discharge cells interposed between a first substrate and a second substrate, the first substrate and the second substrate facing each other and being separated by a predetermined distance; a plurality of discharge electrodes which extend along the lines of the discharge cells so as to cause a discharge; a phosphor layer coated on the inner walls of the discharge cells; and discharge gas filling the inside of the discharge cells.

In addition, the heat prevention layer may include materials used to selectively absorb or reflect infrared radiation waves, the infrared radiation waves being generated as a result of a discharge.

The heat prevention layer is formed by coating heat blocking paste on, or adhering a heat blocking film onto, the image display surface of the PDP, the heat blocking paste and the heat blocking film including materials used to selectively absorb or reflect infrared radiation waves.

In this regard, the materials used to selectively absorb or reflect infrared radiation waves may include dye or pigment which can selectively absorb infrared radiation waves in a wavelength range of 2000 to 2500 nm.

The heat prevention layer may be included in a directly attached filter disposed on the image display surface of the PDP.

In this regard, the direct attached filter may include: a base film; a reflection prevention layer or an anti-glare layer disposed on one side of the base film; an electromagnetic wave shielding layer disposed on the other side of the base film; and an adhesion layer for adhering the directly attached filter to the PDP, the heat prevention layer being formed on any surface of the base film.

In addition, the heat prevention layer may be included in a glass filter disposed so as to be spaced apart from the image display surface of the PDP.

In this regard, the glass filter may include: a tempered glass substrate; a reflection prevention layer or an anti-glare layer disposed on one side of the tempered glass substrate; and an electromagnetic wave shielding layer disposed on the other side of the tempered glass substrate, the heat prevention layer being formed on any surface of the tempered glass substrate.

The plasma display device may further include a front case and a rear case forming an inner space in which the PDP is housed, the tempered glass substrate being fixed to the front case by a holder member which is mounted on the front case by screws.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is an exploded perspective view of a plasma display device according to a first embodiment of the present invention;

FIG. 2 is a cross-sectional view of the plasma display device of FIG. 1, taken along lines II-II and II′-II′ of FIG. 1, according to an embodiment of the present invention;

FIG. 3 is an exploded perspective view of a plasma display device according to a second embodiment of the present invention;

FIG. 4 is a cross-sectional view of a glass filter illustrated in FIG. 3 according to an embodiment of the present invention;

FIG. 5 is an enlarged perspective view of a part V of the plasma display device of FIG. 3 according to an embodiment of the present invention;

FIG. 6 is an exploded perspective view of a plasma display device according to a third embodiment of the present invention; and

FIG. 7 is a cross-sectional view of a directly attached filter taken along a line VII-VII of FIG. 6 according to an embodiment of the present invention.

### DETAILED DESCRIPTION OF THE INVENTION

Hereinafter, the present invention will be described more fully with reference to the accompanying drawings, in which exemplary embodiments of the invention are shown.

### First Embodiment

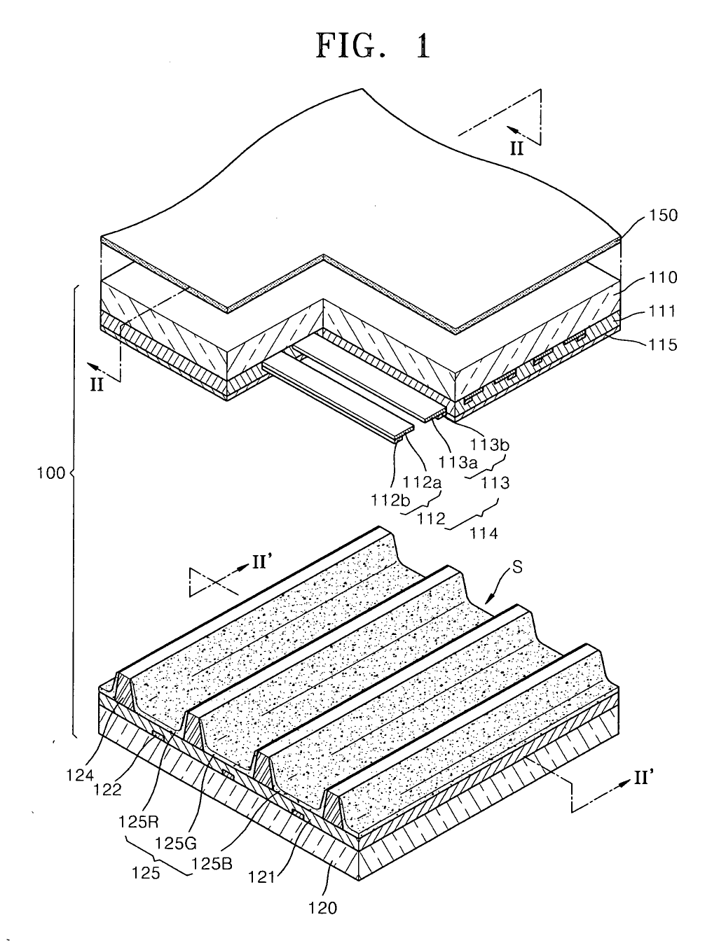

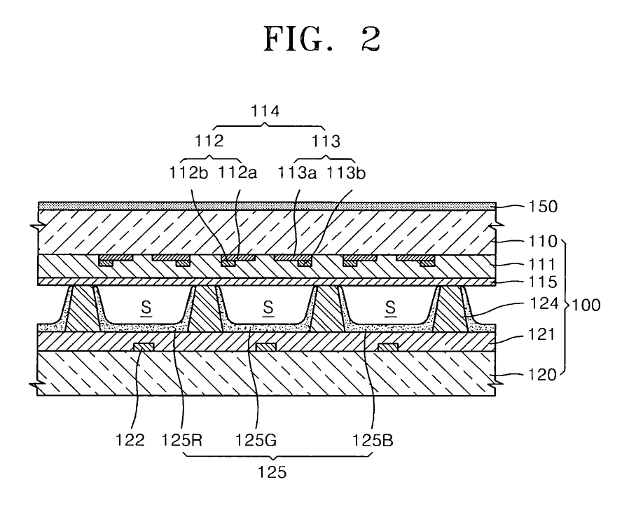

FIG. 1 is an exploded perspective view of a plasma display device according to a first embodiment of the present invention, and FIG. 2 is a cross-sectional view of the plasma display device of FIG. 1, taken along lines II-II and II′-II′ of FIG. 1.

Referring to FIGS. 1 and 2, the plasma display device according to the first embodiment of the present invention includes a plasma display panel (PDP) 100 in which a predetermined image is realized. The PDP 100 includes a heat prevention layer 150 disposed on an image display surface of the PDP 100.

The PDP 100 includes a first substrate 110 and a second substrate 120. The first substrate 110 and the second substrate 120 are disposed so as to face each other with a predetermined interval therebetween. The first substrate 110 may be a glass substrate having excellent visible light transmissivity. In addition, in order to realize a flexible display, the first substrate 110 may comprise an optically transparent plastic material having flexibility. The second substrate 120 may also be a glass substrate or a flexible plastic substrate.

On the first substrate 110, pairs of discharge electrodes 114 which generate a display discharge are arranged in a line. The pairs of discharge electrodes 114 include pairs of first discharge electrodes 112 and second discharge electrodes 113 which may comprise transparent electrodes 112a and 113a formed of a transparent conductive material such as Indium Tin Oxide (ITO), and bus electrodes 112b and 113b disposed so as to contact one surface of the transparent electrodes 112a and 113a in order to compensate for conductivity of the transparent electrodes 112a and 113a. In addition, the first discharge electrodes 112 and second discharge electrodes 113 may be covered by a dielectric layer 111 which is coated on the first substrate 110. The dielectric layer 111 prevents the first discharge electrodes 112 and second discharge electrodes 113 from being damaged by charged particles formed as a result of a discharge, and induces emission of secondary electrons during discharging, thereby providing a suitable environment for discharge. The dielectric layer 111 can be covered and protected by a protection layer 115 which is generally formed of an MgO membrane.

On the second substrate 120, address electrodes 122, extending in a second direction so as to cross the first discharge electrodes 112 and second discharge electrodes 113, are arranged in a line. The address electrodes 122, together with the first discharge electrodes 112 or the second discharge electrodes 113, cause an address discharge so as to select a predetermined discharge cell S in which a display discharge will occur. In addition, a dielectric layer 121, which covers the address electrodes 122, is formed on the second substrate 120.

A plurality of barrier ribs 124, used to partition a space between the first substrate 110 and second substrate 120 into a plurality of the discharge cells S, are interposed between the first substrate 110 and second substrate 120. In this regard, the barrier ribs 124 extend in a stripe pattern so as to define the discharge cells S as having an open type structure. However, the barrier ribs 124 may be in the form of a matrix pattern and define closed-type square discharge cells, or may be formed in a closed-type structure so as to define polygonal, round and oval discharge cells.

A phosphor layer 125 is formed on the inner surfaces of the discharge cells S. More specifically, the phosphor layer 125 is formed on the upper surface of the dielectric layer 121 and on the sidewalls of the barrier ribs 124. The phosphor layer 125 converts ultraviolet rays, generated as a result of a display discharge between the first discharge electrodes 112 and second discharge electrodes 113, into visible rays. Phosphor particles which are changed into an excited state after absorbing ultraviolet rays are changed again into a ground state, and monochromatic light of a specific wavelength range is emitted. The phosphor layer 125 may include red, green, and blue phosphor layers 125R, 125G and 125B, respectively, according to their emitted color. Each discharge cell S forms red, green and blue sub-pixels corresponding to the red, green, and blue phosphor layers 125R, 125G and 125B, respectively.

Although not illustrated in the drawing, discharge gas, which can be excited by a display discharge, fills the discharge cells S.

As an important element of the present invention, the heat prevention layer 150 is formed on the outer surface of the first substrate 110. The heat prevention layer 150 may have two different forms: a layer formed by coating a heat blocking paste, and a layer formed by laminating a heat blocking film. In the former case, heat blocking paste, including dye or pigment which can selectively absorb/block infrared radiation waves in a wavelength range of 2000 to 2500 nm emitted as a result of a discharge, is coated on the surface of the first substrate 110 so as to form the heat prevention layer 150. In the latter case, the heat blocking film, including dye or pigment which absorb/block infrared radiation waves, is laminated on the surface of the first substrate 110 so as to form the heat prevention layer 150. The heat prevention layer 150 can function in one of two ways. That is, the heat prevention layer 150 can absorb infrared radiation waves by itself, or it can reflect radiation waves which are to be emitted into the surrounding environment back into the PDP 100. Thus, the heat prevention layer 150 can include materials having absorption and/or reflection properties with respect to radiation waves.

The heat prevention layer 150 prevents discharged heat from being directly emitted into the surrounding environment, and thus reduces discomfort caused due to the discharged heat, thereby improving customer satisfaction for the product. The PDP 100 may be installed in a structure which includes a front case (not illustrated) and a rear case (not illustrated). However, due to the current trend toward thin display devices, the gap between the PDP 100 and the front case becomes smaller, and thus discharged heat may be directly exposed to users. The plasma display device according to the first embodiment of the present invention includes an additional blocking structure with respect to discharged heat so that a problem of heat discharge caused by thin displays can be solved, thereby avoiding customer dissatisfaction.

### Second Embodiment

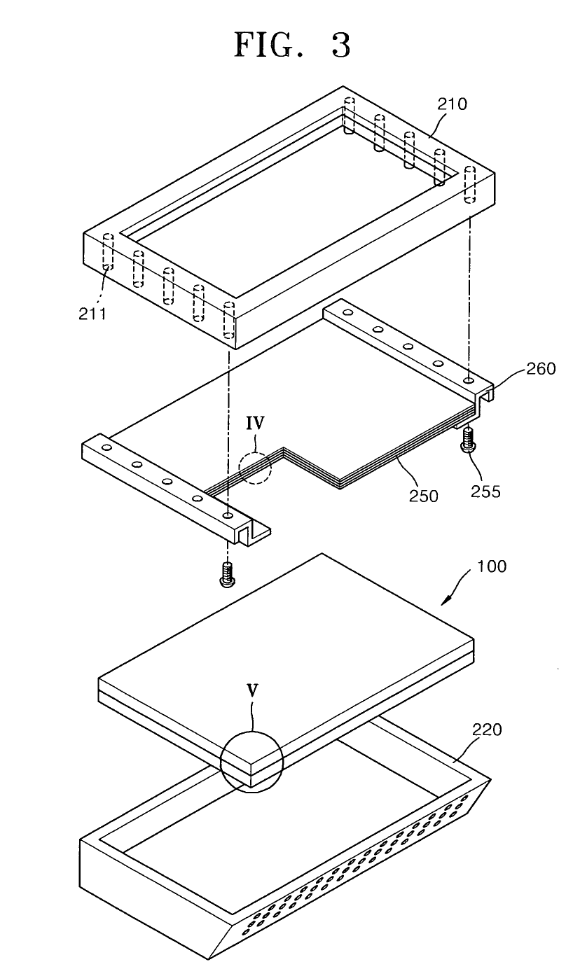

FIG. 3 is an exploded perspective view of a plasma display device according to a second embodiment of the present invention. Referring to FIG. 3, the plasma display device according to the second embodiment of the present invention includes a plasma display panel (PDP) 100 in which a predetermined image is realized, and a glass filter 250 disposed in front of the PDP 100.

The glass filter 250 is fixed in front of the PDP 100 by a holder member 260, the holder member 260 being disposed so as to contact at least two edges of the glass filter 250. The PDP 100 is housed in an inner space between a front case 210 and a rear case 220. In this regard, the holder member 260 is mounted on the front case 210 by screws 255 screwed up into bosses 211 which are formed in the front case 210 by penetrating the holder member 260. In this case, the glass filter 250 is pressurized so as to be fixed between the front case 210 and the holder member 260, and it is spaced apart from the PDP 100 so as to be fixed in front of the PDP 100.

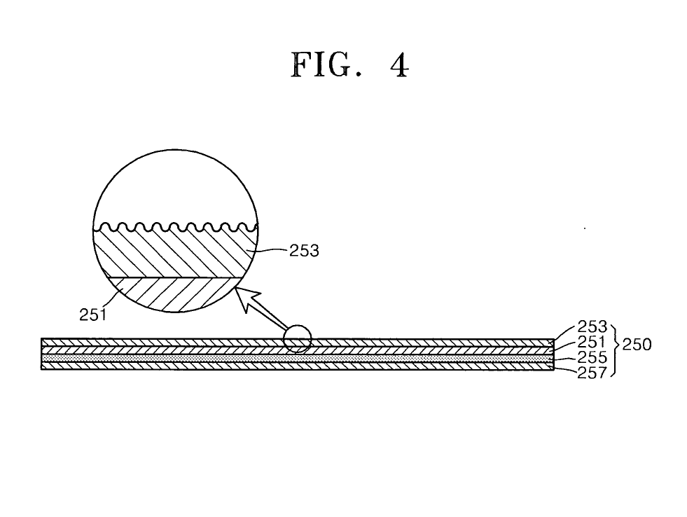

FIG. 4 is a cross-sectional view of the glass filter 250 of FIG. 3 according to an embodiment of the present invention. Referring to FIG. 4, the glass filter 250 includes a tempered glass substrate 251. An anti-glare layer 253 may be formed on one surface of the tempered glass substrate 251 so as to prevent decline of visibility due to external light reflection. The anti-glare layer 253 may include a plurality of protrusion and recess structures in the surface thereof to diffuse external incident light in a wide range of angles, and to prevent external incident light from being reflected from the surface of the glass filter 250, with a resultant decline of image clarity.

In another embodiment of the present invention, the glass filter 250 may include a reflection prevention layer (not illustrated) instead of the anti-glare layer 253, or in addition to the anti-glare layer 253. The reflection prevention layer controls the transmissivity of external incident light so that external incident light is not reflected from the surface of the glass filter 250. For example, the reflection prevention layer may have a multi-layer structure in which at least one metal oxide layer formed of indium tin oxide (ITO) or silicon oxide (SiO₂) is laminated.

An electromagnetic wave shielding layer 257 may be formed on the other surface of the tempered glass substrate 251 so as to efficiently block electromagnetic interference (EMI) waves generated while operating the PDP 100. The electromagnetic wave shielding layer 257 may be formed by patterning conductive metal materials, such as copper (Cu) and silver (Ag), in a mesh type structure. Moreover, a heat prevention layer 255 may be interposed between the tempered glass substrate 251 and the electromagnetic wave shielding layer 257. The heat prevention layer 255 may be formed by coating paste onto or adhering a heat blocking film onto the other surface of the tempered glass substrate 251, the paste and the heat blocking film including a functional material, such as dye or pigment, which can selectively absorb infrared radiation waves generated during a discharge, or reflect infrared radiation waves toward the PDP 100. However, as long as the heat prevention layer 255 can block discharged heat from being emitted due to a plasma discharge, the heat prevention layer 255 can be disposed anywhere in the glass filter 250.

In the current embodiment of the present invention, in order for discharged heat generated inevitably due to a plasma discharge not to be emitted into the surrounding environment, a heat blocking structure is included in the glass filter 250, thereby reducing discomfort normally experienced due to discharged heat. In particular, manufacture of the PDP 100 may be easier when the heat prevention layer 255 is formed in the glass filter 250 as in the current embodiment of the present invention, instead of directly forming a heat prevention layer in the PDP 100, which requires strict quality control during the manufacturing process.

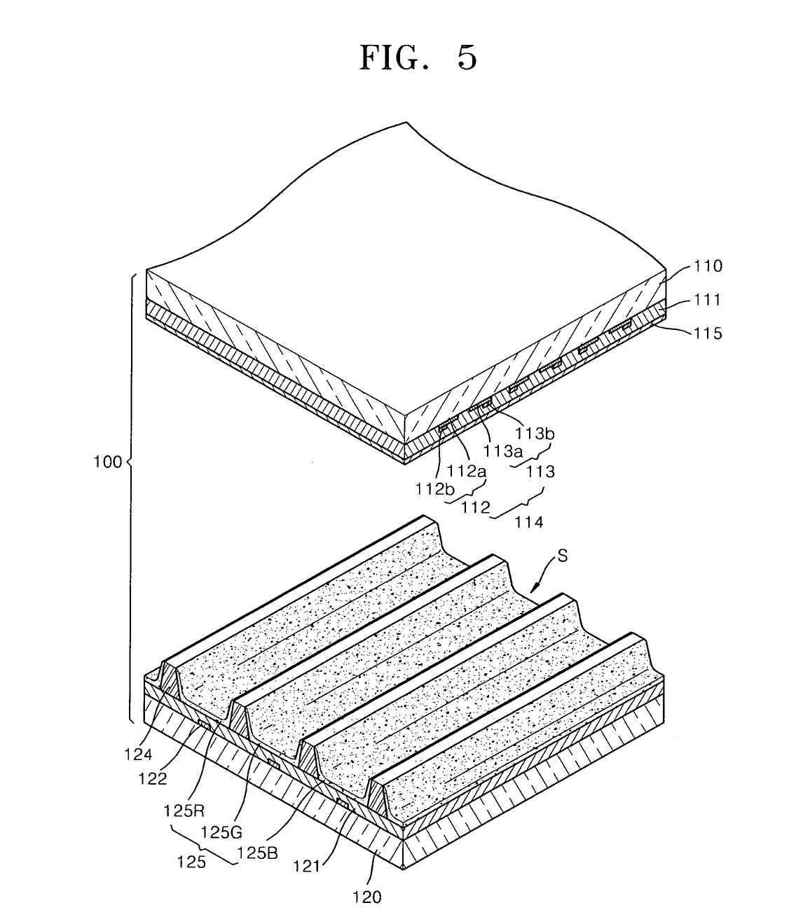

FIG. 5 is an enlarged perspective view of a part V of the PDP 100 of FIG. 3 according to an embodiment of the present invention. Referring to FIG. 5, the PDP100 includes first substrate 110 and second substrate 120. A plurality of discharge cells S, which are defined by barrier ribs 124, are interposed between the first substrate 110 and the second substrate 120. In addition, a plurality of pairs of discharge electrodes 114 are interposed between the first substrate 110 and second substrate 120 so as to form a discharge field. Other technical features of the PDP 100 are the same as those described with reference to the PDP 100 of FIG. 1, and thus detailed descriptions thereof are omitted here.

### Third Embodiment

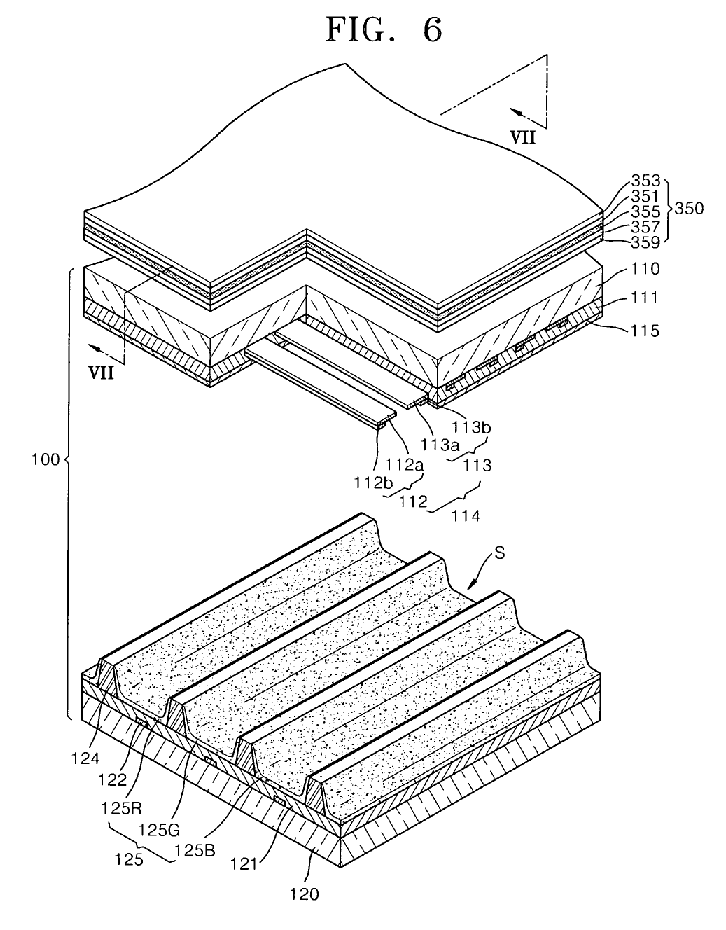

FIG. 6 is an exploded perspective view of a plasma display device according to a third embodiment of the present invention. Referring to FIG. 6, the plasma display device according to the third embodiment of the present invention includes a PDP 100 and a filter 350 directly attached to the front surface of the PDP 100. The directly attached filter 350 improves optical characteristics of images. Also, the directly attached filter 350 blocks electromagnetic interference (EMI) waves generated according to an operation of the plasma display device, and thus prevents malfunction occurring due to interference with external devices.

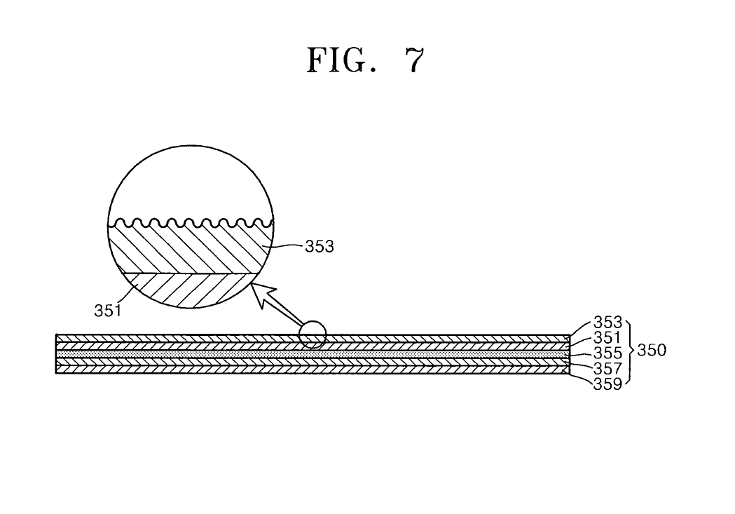

FIG. 7 is a cross-sectional view of the directly attached filter taken along a line VII-VII of FIG. 6 according to an embodiment of the present invention.

Referring to FIG. 7, the directly attached filter 350 includes a base film 351. The base film 351 may be formed of an optically transparent polymer film. Various functional layers, including an anti-glare layer 353, a heat prevention layer 355, an electromagnetic wave shielding layer 357, and an adhesion layer 359, are included in the directly attached filter 350 and directly and indirectly support the base film 351. The anti-glare layer 353 may be disposed on one surface of the base film 351 so as to prevent a decline of visibility due to external light reflection. The anti-glare layer 353 includes a plurality of protrusion and recess structures in the surface thereof to diffuse external incident light in a wide range of angles, and to prevent external incident light from being reflected from the surface of the directly attached filter 350, with resultant decline of image clarity.

In another embodiment of the present invention, the directly attached filter 350 may include a reflection prevention layer (not illustrated) instead of the anti-glare layer 353, or in addition to the anti-glare layer 353. The reflection prevention layer controls transmissivity of external incident light so that external incident light is not reflected from the surface of the directly attached filter 350. For example, the reflection prevention layer may have a multi-layer structure in which at least one metal oxide layer formed of indium tin oxide (ITO) or silicon oxide (SiO₂) is laminated.

The electromagnetic wave shielding layer 357 is formed on the other surface of the base film 351. Since the electromagnetic wave shielding layer 357 prevents electromagnetic interference (EMI) occurring between the PDP 100 and the external environment, malfunction of an external device can be prevented and smooth operation of the PDP 100 can be secured. In order to do so, the electromagnetic wave shielding layer 357 captures electromagnetic interference (EMI) waves generated while operating the PDP 100, and emits the EMI waves to the exterior of the device through a ground line connected to the electromagnetic wave shielding layer 357. The electromagnetic wave shielding layer 357 may be formed by grid patterning or mesh patterning conductive metal materials. Line width or aperture of the conductive metal materials can be appropriately selected by considering transmissivity of visible rays and electromagnetic wave shielding efficiency.

The heat prevention layer 355 is interposed between the base film 351 and the electromagnetic wave shielding layer 357. The heat prevention layer 355 absorbs or reflects discharged heat generated inevitably due to a discharge so that the discharged heat is not emitted into the surrounding environment. As long as the heat prevention layer 355 can block discharged heat, the heat prevention layer 355 can be disposed anywhere in the directly attached filter 350, and is not limited to the current embodiment. The heat prevention layer 355 absorbs infrared radiation waves generated due to a discharge, or reflects infrared radiation waves toward the PDP 100, thereby preventing the emission of radiation waves into the surrounding environment. The heat prevention layer 355 can be formed by coating heat blocking paste or laminating a heat blocking film onto one surface of the base film 351, the heat blocking paste and the heat blocking film including dye or pigment which can selectively absorb infrared radiation waves or reflect infrared radiation waves toward the PDP 100.

The adhesion layer 359 is disposed in the directly attached filter 350 so as to face the PDP 100. The adhesion layer 359 is used to adhere the directly attached filter 350 onto the PDP 100. The adhesion layer 359 may include a compound which absorbs near infrared rays, or may further include coloring materials to compensate for color or to block neon glow so that uniform color can be provided according to the customer's taste.

Meanwhile, in the PDP 100, a first substrate 110 and a second substrate 120 are spaced apart from each other by a predetermined distance and face each other. The PDP 100 includes a plurality of discharge cells S interposed between the first substrate 110 and the second substrate 120. A plurality of discharge electrodes 114 is disposed on the discharge cells S.

Other technical features of the PDP 100 are the same as those described with reference to the PDP 100 of FIG. 1, and thus detailed descriptions thereof are omitted here.

In the current embodiment of the present invention, the directly attached filter 350 is included in the plasma display device in order to improve optical characteristics of images and block electromagnetic interference (EMI) waves, and the heat prevention layer 355 is also included in the directly attached filter 350 so that a heat prevention structure can be formed in a single adhering process. In addition, the heat prevention layer 355 is disposed in the directly attached filter 350, instead of directly being formed in the PDP 100, so as not to adversely affect a PDP in which strict quality control for an image is needed.

In addition, in order for discharged heat inevitably generated due to a plasma discharge not to be emitted into the surrounding environment, the plasma display device includes a radiation wave blocking structure, thereby reducing discomfort normally experienced due to discharged heat.

In particular, due to the current trend toward thin display devices, a PDP in which a plasma display discharge is performed may be directly exposed to the surrounding environment. Therefore, discomfort normally experienced due to discharged heat can be prevented, and the PDP can be formed so as to be thin.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A plasma display device, comprising:
a plasma display panel (PDP) having an image display surface for realizing an image formed due to a discharge; and
a heat prevention layer disposed on a side of the image display surface of the PDP.

2. The device of claim 1, wherein the PDP comprises:
a plurality of discharge cells interposed between a first substrate and a second substrate, the first substrate and the second substrate facing each other and being separated by a predetermined distance;
a plurality of discharge electrodes extending along lines of the discharge cells so as to cause a discharge;
a phosphor layer coated on inner walls of the discharge cells; and
discharge gas filling the interior of the discharge cells.

3. The device of claim 1, wherein the heat prevention layer comprises at least one material used to selectively absorb or reflect infrared radiation waves, and wherein the infrared radiation waves are generated as a result of the discharge.

4. The device of claim 3, wherein the heat prevention layer is formed by coating heat blocking paste on the image display surface of the PDP, and wherein the heat blocking paste comprises at least one material used to selectively absorb or reflect infrared radiation waves.

5. The device of claim 3, wherein the heat prevention layer is formed by adhering a heat blocking film onto the image display surface of the PDP, and wherein the heat blocking film comprises at least one material used to selectively absorb or reflect infrared radiation waves.

6. The device of claim 3, wherein said at least one material used to selectively absorb or reflect infrared radiation waves comprise one of a dye and a pigment which can selectively absorb infrared radiation waves in a wavelength range of 2000 to 2500 nm.

7. The device of claim 1, further comprising a directly attached filter in which the heat prevention layer is included, the directly attached filter being disposed on the image display surface of the PDP.

8. The device of claim 7, wherein the directly attached filter comprises:
a base film;
one of a reflection prevention layer and an anti-glare layer disposed on one side of the base film;
an electromagnetic wave shielding layer disposed on another side of the base film; and
an adhesion layer for adhering the directly attached filter to the PDP;
wherein the heat prevention layer is formed on any surface of the base film.

9. The device of claim 1, further comprising a glass filter in which the heat prevention layer is included, the glass filter being disposed so as to be spaced apart from the image display surface of the PDP.

10. The device of claim 9, wherein the glass filter comprises:
a tempered glass substrate;
one of a reflection prevention layer and an anti-glare layer disposed on one side of the tempered glass substrate; and
an electromagnetic wave shielding layer disposed on another side of the tempered glass substrate;
wherein the heat prevention layer is formed on any surface of the tempered glass substrate.

11. The device of claim 9, further comprising:
a front case and a rear case forming an inner space in which the PDP is housed; and
a holder member mounted on the front case by screws for fixing the tempered glass substrate to the front case.
